(19) United States
(12) Patent Application Publication
(10) Pub. No.: US 2012/0162096 A1
(43) Pub. Date: Jun. 28, 2012

(54) TOUCH DISPLAY PANEL AND TOUCH SENSING PANEL

(75) Inventors: Yi-Hsin Lin, Taipei City (TW); Shin-Shyu Su, Taichung City (TW); Hung-Wen Chou, Taipei City (TW)

(73) Assignee: AU OPTRONICS CORPORATION, Hsinchu (TW)

(21) Appl. No.: 13/043,472

(22) Filed: Mar. 9, 2011

(30) Foreign Application Priority Data
Dec. 23, 2010 (TW) 99145580

(51) Int. Cl. G06F 3/041

(52) U.S. Cl. 345/173

(57) ABSTRACT

A touch display panel includes a first substrate, a second substrate, a display medium layer and a touch electrode layer. The touch electrode layer has sensing regions, and each sensing region includes sub-sensing regions. The touch electrode layer includes driving electrode series and sensing electrode series. Each driving electrode series has driving electrodes, and each driving electrode has sub-driving pattern electrodes. The sensing electrode series intersect the driving electrode series. Each sensing electrode series has a plurality of sensing electrode, and each sensing electrode has sub-sensing pattern electrodes. Each sub-sensing pattern electrode has a sensing circumference, and the sensing circumferences of the sub-sensing pattern electrodes of the sub-sensing regions in a single sensing region are different, or each sub-driving pattern electrode has a driving circumference and the driving circumferences of the sub-driving pattern electrodes of the sub-sensing regions in a single sensing region are different.

### CROSS-REFERENCE TO RELATED APPLICATION

This application claims the priority benefit of Taiwan application serial no. 99145580, filed Dec. 23, 2010. The entirety of the above-mentioned patent application is hereby incorporated by reference herein and made a part of this specification.

### BACKGROUND OF THE INVENTION

1. Field of the Invention

The invention relates to a touch panel and more particularly to a capacitive touch display panel and a capacitive touch sensing panel.

2. Description of Related Art

In the current information society, people gradually relied more on their electronic products. Electronic products such as mobile phones, handheld personal computers, personal digital assistance (PDA), and smart phones are highly adopted in daily lives. Many information products adopting traditional input devices such as keyboards and mice are now applying touch panels as input devices for convenience, compact volume, and user friendliness. Herein, touch display panels having both touch sensing and display functions are one of the most popular products in the market.

Conventionally, a touch display panel includes a display panel and a touch sensing panel. The touch sensing panel is built-in inside the display panel or adhered on the display panel. The touch sensing panel is generally categorized into resistive touch sensing panel, capacitive touch sensing panel, optical touch sensing panel, acoustic-wave touch sensing panel, and magnetic touch sensing panel according to the sensing method. Taking the capacitive touch sensing panel as an example, a uniform electric field is mainly generated thereon. Thus, a small capacitance change is generated when a conductor (i.e. a finger) contacts with the capacitive touch sensing panel, such that coordinates of the pressed position on the panel can be determined.

As for the conventional touch display panel, the resolution required by the touch display panel increases with the increasing resolution of the display panel. The number of channels increases as well, so that the number of control chips required also increases. Therefore, when designing the touch display panel, it is important to increase the resolution of the touch display panel while controlling the number of channels.

### SUMMARY OF THE INVENTION

The invention is directed to a touch display panel and a touch sensing panel having superior sensitivity.

The invention is directed to a touch display panel including a first substrate, a second substrate, a display medium layer, and a touch electrode layer. The first substrate has a pixel array disposed thereon. The second substrate is disposed opposite to the first substrate. The display medium layer is disposed between the first substrate and the second substrate. The touch electrode layer is disposed on the second substrate. The touch electrode layer has a plurality of sensing regions and a single sensing region includes a plurality of sub-sensing regions. The touch electrode layer includes a plurality of driving electrode series and a plurality of sensing electrode series. The driving electrode series extend along a first direction. Each of the driving electrode series has a plurality of driving electrodes. Each of the driving electrodes has a plurality of sub-driving pattern electrodes, and the sub-driving pattern electrodes of each of the driving electrodes are disposed in the sub-sensing regions of the corresponding sensing region respectively. The sensing electrode series extend along a second direction and intersect the driving electrode series. Each of the sensing electrode series has a plurality of sensing electrodes. Each of the sensing electrodes has a plurality of sub-sensing pattern electrodes, and the sub-sensing pattern electrodes of each of the sensing electrodes are disposed in the sub-sensing regions of the corresponding sensing region respectively. Each of the sub-sensing pattern electrodes has a sensing circumference. The sensing circumferences of the sub-sensing pattern electrodes in the sub-sensing regions of each of the sensing regions are different.

The invention is further directed to a touch sensing panel including a panel, a plurality of driving electrodes and a plurality of sensing electrodes. The substrate has a plurality of sensing regions, and each of the sensing regions includes a plurality of sub-sensing regions. Each of the driving electrodes has a plurality of sub-driving pattern electrodes, and the sub-driving pattern electrodes of each of the driving electrodes are disposed in the sub-sensing regions of the corresponding sensing region respectively. Each of the sensing electrodes has a plurality of sub-sensing pattern electrodes, and the sub-sensing pattern electrodes of each of the sensing electrodes are disposed in the sub-sensing regions of the corresponding sensing region respectively. Each of the sub-sensing pattern electrodes has a sensing circumference. The sensing circumferences of the sub-sensing pattern electrodes in the sub-sensing regions of each of the sensing regions are different.

The invention is further directed to a touch display panel including a first substrate, a second substrate, a display medium layer, and a touch electrode layer. The first substrate has a pixel array disposed thereon. The second substrate is disposed opposite to the first substrate. The display medium layer is disposed between the first substrate and the second substrate. The touch electrode layer is disposed on the second substrate. The touch electrode layer has a plurality of sensing regions and a single sensing region includes a plurality of sub-sensing regions. The touch electrode layer includes a plurality of sensing electrode series and a plurality of driving electrode series. The sensing electrode series extend along a first direction. Each of the sensing electrode series has a plurality of sensing electrodes. Each of the sensing electrodes has a plurality of sub-sensing pattern electrodes, and the sub-sensing pattern electrodes of each of the sensing electrodes is disposed in the sub-sensing regions of the corresponding sensing region respectively. The driving electrode series extend along a second direction and intersect the sensing electrode series. Each of the driving electrode series has a plurality of driving electrodes. Each of the driving electrodes has a plurality of sub-driving pattern electrodes, and the sub-driving pattern electrodes of each of the driving electrodes are disposed in the sub-sensing regions of the corresponding sensing region respectively. Each of the sub-sensing regions has a driving circumference. At least one of the driving circumferences of the sub-driving pattern electrodes in the sub-sensing regions in each of the sensing regions is different.

The invention is further directed to a touch sensing panel including a panel, a plurality of sensing electrodes and a plurality of driving electrodes. The substrate has a plurality of sensing regions, and each of the sensing regions includes a plurality of sub-sensing regions. Each of the sensing electrodes has a plurality of sub-sensing pattern electrodes, and the sub-sensing pattern electrodes of each of the sensing electrodes is disposed in the sub-sensing regions of the corresponding sensing region respectively. Each of the driving electrodes has a plurality of sub-driving pattern electrodes, and the sub-driving pattern electrodes of each of the driving electrodes are disposed in the sub-sensing regions of the corresponding sensing region respectively. Each of the sub-sensing regions has a driving circumference. The driving circumferences of the sub-driving pattern electrodes in the sub-sensing regions in each of the sensing regions are different.

In light of the foregoing, in the touch display panel of the invention, as each driving electrode and each sensing electrode of the touch electrode layer have a plurality of sub-driving pattern electrodes and a plurality of sub-sensing pattern electrodes respectively, the sensing circumferences of the sub-sensing pattern electrodes in the sub-sensing regions in a single sensing region are different. Thus, when the user touches the touch display panel, multiple levels of touch senses can be sensed within a single sensing region. The touch operation thus has superior touch sensitivity and the number of channels can be reduced. In short, the structural design of the touch electrode layer in the invention facilitates in increasing the touch sensitivity of the touch display panel and decreasing the number of channels.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1A is a cross-sectional view illustrating a touch display panel according to an embodiment of the invention.

FIG. 1B is a top view illustrating a first substrate in FIG. 1A.

FIG. 1C is a top view illustrating a touch sensing panel in FIG. 1A.

FIG. 1D is a top view illustrating a sensing region of a touch electrode layer in FIG. 1C.

FIG. 1E is a cross-sectional view taken along line I-I in FIG. 1D.

FIG. 2 is a cross-sectional view illustrating a touch display panel according to another embodiment of the invention.

FIG. 3 is a cross-sectional view illustrating a touch display panel according to another embodiment of the invention.

FIG. 4 is a top view illustrating a sensing region of a touch electrode layer according to another embodiment of the invention.

### DESCRIPTION OF EMBODIMENTS

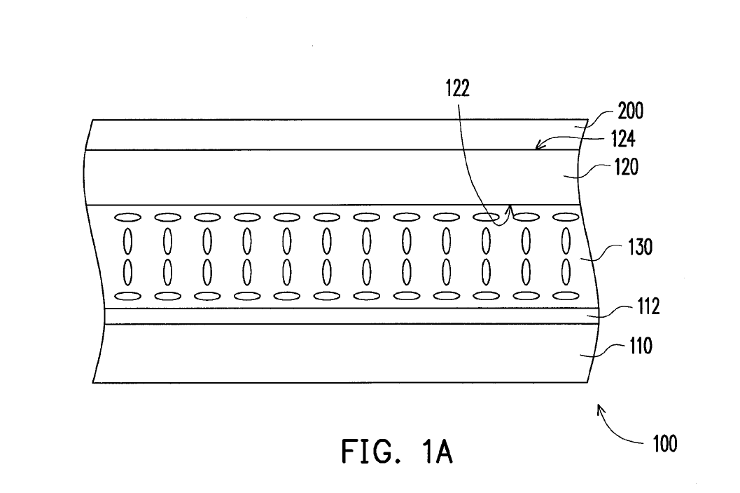

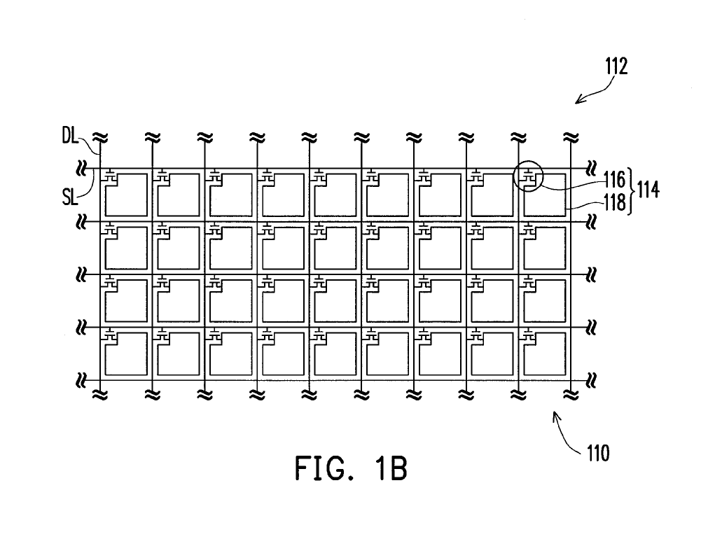

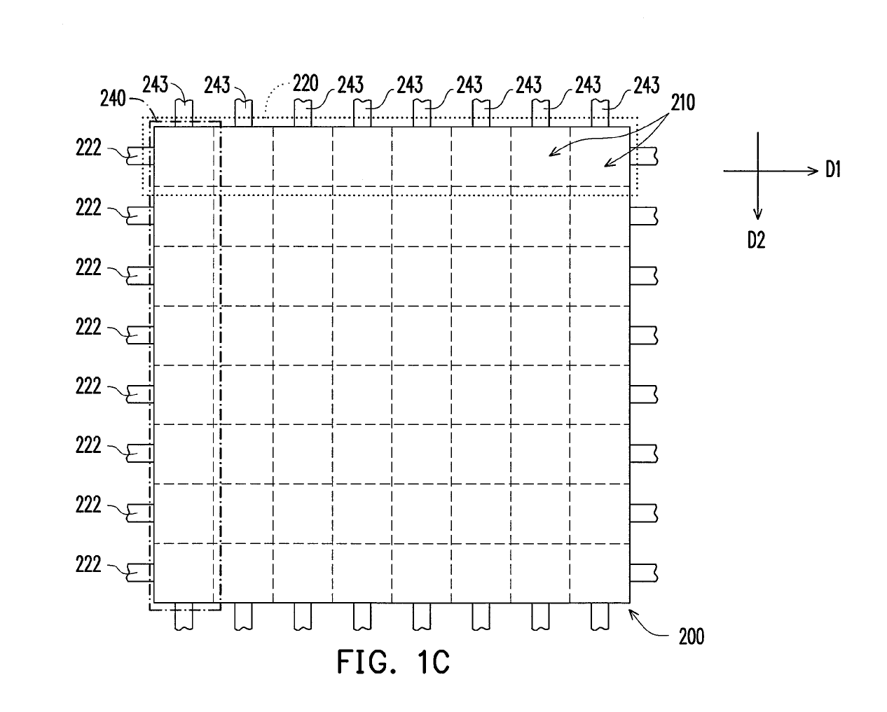

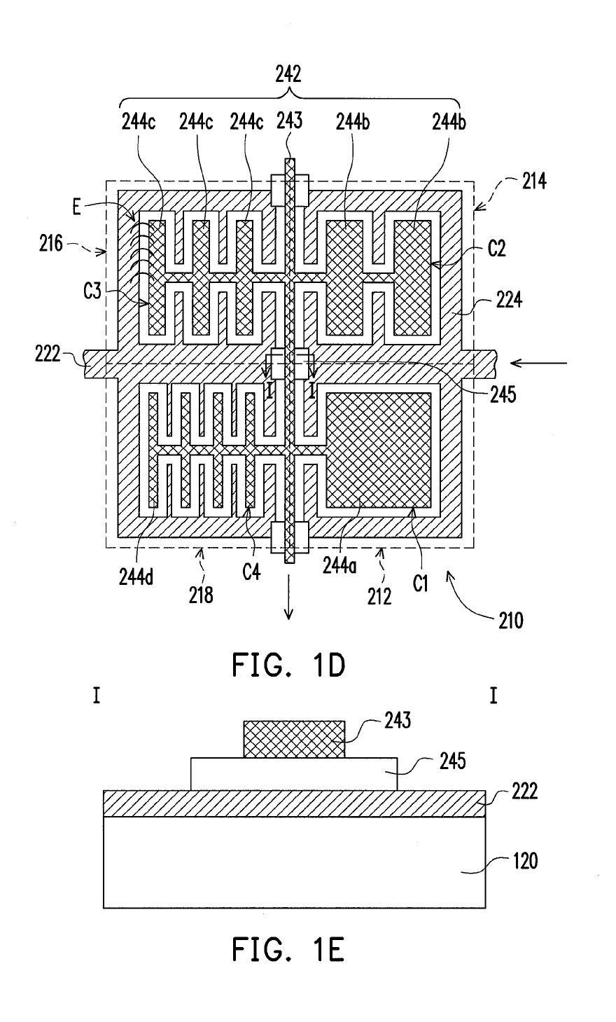

FIG. 1A is a cross-sectional view illustrating a touch display panel according to an embodiment of the invention. FIG. 1B is a top view illustrating a first substrate in FIG. 1A. FIG. 1C is a top view illustrating a touch electrode layer in FIG. 1A. FIG. 1D is a top view illustrating a sensing region of a touch electrode layer in FIG. 1C. FIG. 1E is a cross-sectional view taken along line I-I in FIG. 1D. Referring to FIG. 1A, a touch display panel 100 of the present embodiment includes a first substrate 110, a second substrate 120, a display medium layer 130, and a touch electrode layer 200. The second substrate 120 is disposed opposite to the first substrate 110. The second substrate 120 has an inner surface 122 and an outer surface 124 facing the inner surface 122. The display medium layer 130 is disposed between the first substrate 110 and the second substrate 120. The touch electrode layer 200 is disposed on the outer surface 124 of the second substrate 120. Herein, the touch electrode layer 200 and the second substrate 120 constitute a touch sensing panel.

In the present embodiment, the first substrate 110 and the second substrate 120 are, for example, glass substrates, plastic substrates, or other suitable substrates. The display medium layer 130 is made of a liquid crystal material, for instance. In other words, the touch display panel 100 of the present embodiment is, for instance, a touch liquid crystal display panel. The display medium layer 130 can also be made of other display material, for example, an organic light emitting material, an electrophoretic display material, or a plasma display material. As a consequence, the touch display panel 100 can also be a touch organic light emitting display panel, a touch electrophoretic display panel, or a touch plasma display panel. Details of the display material and the panel structure should be understood by persons skilled in the art, and the descriptions thereof are omitted hereinafter.

Referring to FIGS. 1A and 1B simultaneously, an active layer 112 is disposed on the first substrate 110. The active layer 112 includes a plurality of pixel structures 114. Generally, each of the pixel structures 114 includes an active device 116 and a pixel electrode 118 electrically connected to the active device 116. The active device 116 is, for example, a thin film transistor (TFT). Each of the pixel structures 114 is electrically connected to a data line DL and a scan line SL corresponding thereto through the active device 116. As the pixel structures 114 are well-known to persons of common knowledge in the art, the descriptions thereof are omitted hereinafter. Additionally, the pixel structures 114 shown in FIG. 1B are merely examples of the pixel structures 114 and are not used to limit the structure or disposition of the pixel structures 114.

Referring to FIGS. 1C and 1D, in the present embodiment, the touch electrode layer 200 has a plurality of sensing regions 210. Each of the sensing regions 210 includes a plurality of sub-sensing regions such as a first sub-sensing region 212, a second sub-sensing region 214, a third sub-sensing region 216, and a fourth sub-sensing region 218 depicted in FIG. 1D. In details, the touch electrode layer 200 includes a plurality of driving electrode series 220 and a plurality of sensing electrode series 240. The driving electrode series 220 extend along a first direction D1, and each of the driving electrode series 220 has a plurality of driving electrodes 222. Each of the driving electrodes 222 has a plurality of sub-driving pattern electrodes 224. The sub-driving pattern electrodes 224 of each of the driving electrodes 222 is disposed in the sub-sensing regions of the corresponding sensing region 210 respectively (such as the first sub-sensing region 212, the second sub-sensing region 214, the third sub-sensing region 216, or the fourth sub-sensing region 218).

The sensing electrode series 240 extend along a second direction D2 and intersect the driving electrode series 220. Each of the sensing electrode series 240 has a plurality of sensing electrodes 242. Each of the sensing electrodes 242 has a plurality of sub-sensing pattern electrodes 244a, 244b, 244c, 244d. The sub-sensing pattern electrodes 244a, 244b, 244c, 244d of each of the sensing electrodes 242 are disposed in the sub-sensing regions of the corresponding sensing region 210 respectively (such as the first sub-sensing region 212, the second sub-sensing region 214, the third sub-sensing region 216, or the fourth sub-sensing region 218). The sub-sensing pattern electrodes 224 in each of the sub-sensing regions (such as the first sub-sensing region 212, the second sub-sensing region 214, the third sub-sensing region 216, or the fourth sub-sensing region 218) surround the sub-sensing pattern electrodes 244a, 244b, 244c, 244d.

Particularly, in the present embodiment, the sub-driving pattern electrodes 224 and the sub-sensing pattern electrodes 244a, 244b, 244c, 244d in each of the sub-sensing regions (such as the first sub-sensing region 212, the second sub-sensing region 214, the third sub-sensing region 216, and the fourth sub-sensing region 218) have the same distance therebetween. Herein, the sub-driving pattern electrodes 224 and the sub-sensing pattern electrodes 244a, 244b, 244c, 244d have a spacing distance therebetween and are electrically insulated from each other. Each of the sub-sensing pattern electrodes 244a, 244b, 244c, 244d has a sensing circumference respectively. The sensing circumferences of the sub-sensing pattern electrodes 244a, 244b, 244c, 244d in the sub-sensing regions of each of the sensing regions 210 are different. It should be noted that the sensing circumference refers the length required for surrounding each of the sub-sensing pattern electrodes 244a, 244b, 244c, 244d.

For example, referring to FIG. 1D, the sub-sensing pattern electrode 244a in the first sub-sensing region 212 has a first sensing circumference C1, the sub-sensing pattern electrode 244b in the second sub-sensing region 214 has a second sensing circumference C2, the sub-sensing pattern electrode 244c in the third sub-sensing region 216 has a third sensing circumference C3, and the sub-sensing pattern electrode 244d in the fourth sub-sensing region 218 has a fourth sensing circumference C4. Herein, the length of the second sensing circumference C2 is about two times of that of the first sensing circumference C1. The length of the third sensing circumference C3 is about three times of that of the first sensing circumference C1. The length of the fourth sensing circumference C4 is about four times of that of the first sensing circumference C1. Further, the areas of the sub-sensing pattern electrodes 244a, 244b, 244c, 244d in the sub-sensing regions of each of the sensing regions 210 (such as the first sub-sensing region 212, the second sub-sensing region 214, the third sub-sensing region 216, and the fourth sub-sensing region 218) are the same or different, and the invention is not limited thereto. Moreover, a driving circumference of each of the sub-driving pattern electrodes 224 in the sub-driving electrodes in the sub-driving regions of each of the sensing regions 210 is different and can be adjusted corresponding to the sensing circumferences of the sub-sensing pattern electrodes 244a, 244b, 244c, 244d.

For example, each of the sub-sensing regions is 5 mm*5 mm (5000 μm*5000 μm). In the first sub-sensing region 212, the first sensing circumference C1 of the sub-sensing pattern electrode 244a is designed to be 12000 μm and a first driving circumference of the sub-driving pattern electrode 224 is designed to be 33870 μm. In the third sensing region 216, the third sensing circumference C3 of the sub-sensing pattern electrode 244c is designed to be 34400 μm and a third driving circumference of the sub-driving pattern electrode 224 is correspondingly designed to be 57121 μm. Therefore, the length of the third sensing circumference C3 is about three times of that of the first sensing circumference C1. Accordingly, when the user's finger touches the third sub-sensing region 216 and the first sub-sensing region 212 respectively, a sensing signal change in the third sub-sensing region 216 is about three times of that in the first sub-sensing region 212, and different sensing positions can be distinguished therefrom.

In addition, the sensing circumferences of the sub-sensing pattern electrodes 244a, 244b, 244c, 244d in the sub-sensing regions of each of the sensing regions 210 are different. The sub-driving pattern electrodes and the sub-sensing pattern electrodes 244a, 244b, 244c, 244d respectively have a lateral electric field E therebetween. Since the sensing circumferences of the sub-sensing pattern electrodes 244a, 244b, 244c, 244d in the sub-sensing regions of each of the sensing regions 210 are different, the values of the lateral electric fields E in the sub-sensing regions of each of the sensing regions 210 (such as the first sub-sensing region 212, the second sub-sensing region 214, the third sub-sensing region 216, and the fourth sub-sensing region 218) are different.

Referring to FIG. 1E, in the present embodiment, each of the sensing electrode series 240 has a plurality of sensing bridge lines 243. The sensing bridge lines 243 cross the driving electrode series 220 and are connected to the neighboring sub-sensing pattern electrodes 244a, 244b, 244c, 244d on respective sides. The touch electrode layer 200 further includes an insulation layer 245. The insulation layer 245 is disposed between the sensing bridge lines 243 and the driving electrode series 220 to electrically insulate the driving electrode series 220 and the sensing electrode series 240.

Since each of the driving electrodes 222 of the present embodiment has a plurality of sub-driving pattern electrodes 224. Each of the sensing electrodes 242 has a plurality of sub-sensing pattern electrodes 244a, 244b, 244c, 244d. The sub-driving pattern electrodes 224 in each of the sub-sensing regions (such as the first sub-sensing region 212, the second sub-sensing region 214, the third sub-sensing region 216, and the fourth sub-sensing region 218) surround the sub-sensing pattern electrodes 244a, 244b, 244c, 244d. Moreover, the sensing circumferences of the sub-sensing pattern electrodes 244a, 244b, 244c, 244d (such as the first sensing circumference C1, the second sensing circumference C2, the third sensing circumference C3, and the fourth sensing circumference C4) in the sub-sensing regions in each of the sensing regions 210 (such as the first sub-sensing region 212, the second sub-sensing region 214, the third sub-sensing region 216, and the fourth sub-sensing region 218) are different. Thus, when the user uses the touch display panel 100, different levels of sensing voltage signal changes are generated as different sub-sensing regions in the same sensing region 210 are pressed. The touch sensitivity is thus enhanced in operation. In short, the structural design of the touch electrode layer 200 of the present embodiment facilitates in enhancing the touch sensitivity of the touch display panel 100, such that the touch display panel 100 has higher resolution with the same number of channels.

It should be illustrated that the invention does not limit the type of the sensing regions 210. Here, each of the sensing regions 210 is specified to include a first sub-sensing region 212, a second sub-sensing region 214, a third sub-sensing region 216, and a fourth sub-sensing region 218. However, in embodiments not shown herein, each of the sensing regions 210 can also include a first sub-sensing region 212 and a second sensing region 214. In this case, the length of the second sensing circumference C2 of the sub-sensing pattern electrode 244b in the second sub-sensing region 214 is about three times of that of the first sensing circumference C1 of the sub-sensing pattern electrode 244a in the first sensing region 212. In short, the sensing region 210 shows in FIG. 1D is merely illustrative, but the invention is not limited thereto. Persons skilled in the field can refer to the illustrations of the embodiments aforementioned, and the number of the sub-sensing regions can be increased according to actual demands to attain the effects as needed.

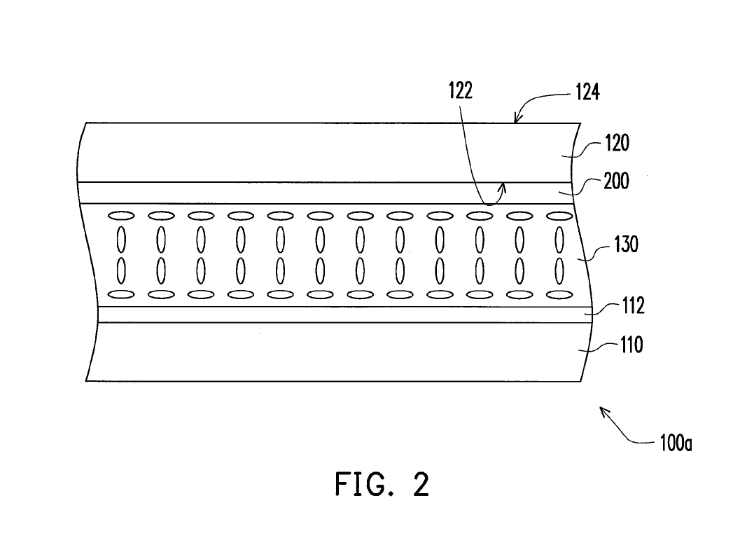

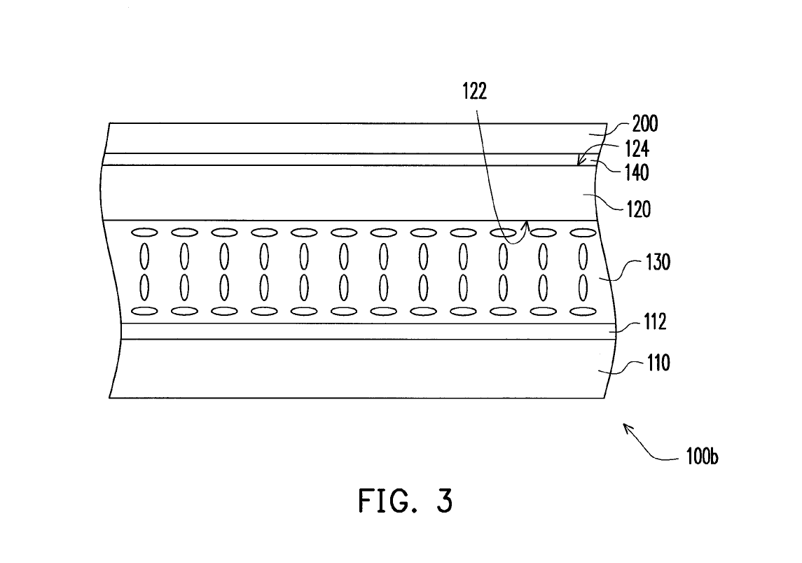

Also, in the embodiments aforementioned, as depicted in FIG. 1A, the touch electrode layer 200 is disposed on the outer surface 124 of the second substrate 120. However, in another embodiment, as shown in FIG. 2, in a touch display panel 100a, the touch electrode layer 200 can also be disposed on the inner surface 122 of the second substrate 120. In another embodiment, as shown in FIG. 3, a touch display panel 100b further includes an auxiliary substrate 140. The auxiliary substrate 140 is disposed on the outer surface 124 of the second substrate 120. The touch electrode layer 200 is disposed on the auxiliary substrate 140. In other words, the touch electrode layer 200 can be built-in in the display panel as illustrated in FIG. 1A (the display panel refers to the structure constituted by the first substrate 110, the second substrate 120, and the display medium 130 disposed therebetween) or adhered on the display panel as depicted in FIGS. 2 and 3.

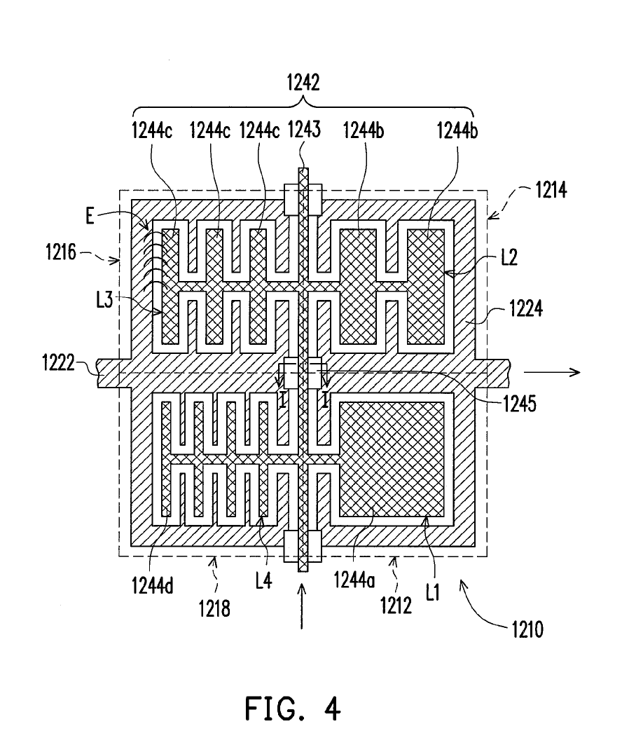

In another embodiment, the sensing electrodes and the driving electrodes can be exchanged by changing the manner of connecting the circuits to attain the same effects. Referring to FIG. 4, each of a plurality of driving electrodes 1242 has a plurality of sub-driving pattern electrodes 1244a, 1244b, 1244c, 1244d. The sub-driving pattern electrode 1244a in a first sub-sensing region 1212 has a first driving circumference L1, the sub-driving pattern electrode 1244b in a second sub-sensing region 1214 has a second driving circumference L2, the sub-driving pattern electrode 1244c in a third sub-sensing region 1216 has a third driving circumference L3, and the sub-driving pattern electrode 1244d in a fourth sub-sensing region 1218 has a fourth driving circumference L4. Herein, the length of the second driving circumference L2 is about two times of that of the first driving circumference L1. The length of the third driving circumference L3 is about three times of that of the first driving circumference L1. The length of the fourth driving circumference L4 is about four times of that of the first driving circumference L1. Further, the areas of the sub-sensing pattern electrodes 1244a-1244d in the sub-sensing regions of each of a plurality of sensing regions 1210 (such as the first sub-sensing region 1212, the second sub-sensing region 1214, the third sub-sensing region 1216, and the fourth sub-sensing region 1218) are the same or different, and the invention is not limited thereto. Moreover, a driving circumference of each of a plurality of sub-sensing pattern electrodes 1224 in a plurality of sensing electrodes 1222 in the sub-sensing regions of each of the sensing regions 1210 is different and can be adjusted corresponding to the driving circumferences of the sub-driving pattern electrodes.

In addition, the driving circumferences of a plurality of sub-driving pattern electrodes 1244 in the sub-sensing regions of each of the sensing regions 1210 are different. The sub-sensing pattern electrodes 1224 and the sub-driving pattern electrodes 1244 have a lateral electric field E respectively. Since the driving circumferences of the sub-driving pattern electrodes 1244 in the sub-sensing regions of each of the sensing regions 1210 are different, the values of the lateral electric fields E in the sub-sensing regions of each of the sensing regions 1210 (such as the first sub-sensing region 1212, the second sub-sensing region 1214, the third sub-sensing region 1216, and the fourth sub-sensing region 1218) are different. Additionally, an insulation layer 1245 is disposed between a plurality of sensing bridge lines 1243 and a plurality of driving electrode series (not shown) to electrically insulate the driving electrode series and the sensing electrode series (not shown).

Thus, when the user uses the touch display panel 100, different levels of sensing voltage signal changes are generated as different sub-sensing regions in the same sensing region 1210 are pressed. Accordingly, the touch sensitivity is thus enhanced in operation. In short, the structural design of the touch electrode layer 200 of the present embodiment facilitates in enhancing the touch sensitivity of the touch display panel 100, such that the touch display panel 100 has higher resolution with the same number of channels. The touch electrode layer 200 of the above embodiment can be integrated with the display panel as depicted in FIGS. 2 and 3 and the details are omitted hereinafter.

In summary, in the touch display panel of the invention, as each driving electrode and each sensing electrode of the touch electrode layer have a plurality of sub-driving pattern electrodes and a plurality of sub-sensing pattern electrodes respectively, the sensing circumferences of the sub-sensing pattern electrodes in the sub-sensing regions in a single sensing region are different. Thus, when the user utilizes the touch display panel, different levels of sensing voltage signal changes are generated as different sub-sensing regions in the same sensing region are pressed. As a consequence, the number of channels required to attain the same resolution can be reduced or higher resolution can be obtained with the same number of channels in operation.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch display panel, comprising:
a first substrate having a pixel array disposed thereon;
a second substrate disposed opposite to the first substrate;
a display medium layer disposed between the first substrate and the second substrate; and
a touch electrode layer disposed on the second substrate and having a plurality of sensing regions each comprising a plurality of sub-sensing regions, wherein the touch electrode layer comprises:
a plurality of driving electrode series extending along a first direction, wherein each of the driving electrode series has a plurality of driving electrodes, each of the driving electrodes has a plurality of sub-driving pattern electrodes, and the sub-driving pattern electrodes of each of the driving electrodes are disposed in the sub-sensing regions of a corresponding sensing region respectively; and
a plurality of sensing electrode series extending along a second direction and intersecting the driving electrode series, wherein each of the sensing electrode series has a plurality of sensing electrodes, each of the sensing electrodes has a plurality of sub-sensing pattern electrodes, the sub-sensing pattern electrodes of each of the sensing electrodes are disposed in the sub-sensing regions of the corresponding sensing region respectively, and each of the sub-sensing pattern electrodes has a sensing circumference, wherein the sensing circumferences of the sub-sensing pattern electrodes in the sub-sensing regions of each of the sensing regions are different.

2. The touch display panel as claimed in claim 1, wherein areas of the sub-sensing pattern electrodes in the sub-sensing regions of each of the sensing regions are the same.

3. The touch display panel as claimed in claim 1, wherein areas of the sub-sensing pattern electrodes in the sub-sensing regions of each of the sensing regions are different.

4. The touch display panel as claimed in claim 1, wherein each of the sensing regions comprises a first sub-sensing region and a second sub-sensing region respectively having a first sensing circumference and a second sensing circumference, and a length of the second sensing circumference is substantially three times of a length of the first sensing circumference.

5. The touch display panel as claimed in claim 1, wherein each of the sensing regions comprises a first sub-sensing region, a second sub-sensing region, a third sub-sensing region, and a fourth sub-sensing region respectively having a first sensing circumference, a second sensing circumference, a third sensing circumference, and a fourth sensing circumference, and a length of the second sensing circumference is substantially two times of a length of the first sensing circumference, a length of the third sensing circumference is substantially three times of the length of the first sensing circumference, and a length of the fourth sensing circumference is substantially four times of the length of the first sensing circumference.

6. The touch display panel as claimed in claim 1, wherein each of the sensing electrode series has a plurality of sensing bridge lines crossing the driving electrode series and connected the neighboring sub-sensing electrodes on respective sides.

7. The touch display panel as claimed in claim 6, wherein the touch electrode layer further comprises an insulation layer disposed between the sensing bridge lines and the driving electrode series to electrically insulate the driving electrode series and the sensing electrode series.

8. The touch display panel as claimed in claim 1, wherein a distance between the sub-driving pattern electrode and the sub-sensing pattern electrode in each of the sub-sensing regions is the same.

9. The touch display panel as claimed in claim 1, wherein the sub-driving pattern electrode and the sub-sensing pattern electrode in each the sub-sensing regions have a lateral electric field therebetween, and the lateral electric fields in the sub-sensing regions of each of the sensing regions are different.

10. The touch display panel as claimed in claim 1, wherein the second substrate has an inner surface and an outer surface, and the touch electrode layer is disposed on the inner surface.

11. The touch display panel as claimed in claim 1, wherein the second substrate has an inner surface and an outer surface, and the touch electrode layer is disposed on the outer surface.

12. The touch display panel as claimed in claim 1, further comprising an auxiliary substrate disposed on the second substrate, wherein the touch electrode layer is disposed on the auxiliary substrate.

13. The touch display panel as claimed in claim 1, wherein the sub-driving pattern electrode in each of the sub-sensing regions surrounds the sub-sensing pattern electrode.

14. The touch display panel as claimed in claim 1, wherein the sub-driving pattern electrodes in the sub-sensing regions of each of the sensing regions have different driving circumferences.

15. A touch sensing panel, comprising:
a substrate having a plurality of sensing regions, each of the sensing regions comprising a plurality of sub-sensing regions;
a plurality of driving electrodes, each of the driving electrodes having a plurality of sub-driving pattern electrodes, wherein the sub-driving pattern electrodes of each of the driving electrodes are disposed in the sub-sensing regions of a corresponding sensing region respectively; and
a plurality of sensing electrodes, each of the sensing electrodes having a plurality of sub-sensing pattern electrodes, the sub-sensing pattern electrodes of each of the sensing electrodes disposed in the sub-sensing regions of a corresponding sensing region respectively, and each of the sub-sensing pattern electrodes having a sensing circumference, wherein the sensing circumferences of the sub-sensing pattern electrodes in the sub-sensing regions in each of the sensing regions are different.

16. The touch sensing panel as claimed in claim 15, wherein the sensing electrodes are arranged into a plurality of sensing electrode series, the driving electrodes are arranged into a plurality of driving electrode series, and an extending direction of the sensing electrode series and an extending direction of the driving electrode series are different.

17. The touch sensing panel as claimed in claim 15, wherein a distance between the sub-driving pattern electrode and the sub-sensing pattern electrode in each of the sub-sensing regions is the same.

18. The touch sensing panel as claimed in claim 15, wherein the sub-driving pattern electrode and the sub-sensing pattern electrode in each sub-sensing region have a lateral electric field therebetween, and the lateral electric fields in the sub-sensing regions of each of the sensing regions are different.

19. A touch display panel, comprising:
a first substrate having a pixel array disposed thereon;
a second substrate disposed opposite to the first substrate;
a display medium layer disposed between the first substrate and the second substrate; and
a touch electrode layer disposed on the second substrate and having a plurality of sensing regions each comprising a plurality of sub-sensing regions, wherein the touch electrode layer comprises:
a plurality of sensing electrode series extending along a first direction, wherein each of the sensing electrode series has a plurality of sensing electrodes, each of the sensing electrodes has a plurality of sub-sensing pattern electrodes, and the sub-sensing pattern electrodes of each of the sensing electrodes is disposed in the sub-sensing regions of a corresponding sensing region respectively; and
a plurality of driving electrode series extending along a second direction and intersecting the sensing electrode series, wherein each of the driving electrode series has a plurality of driving electrodes, each of the driving electrodes has a plurality of sub-driving pattern electrodes, the sub-driving pattern electrodes of each of the driving electrodes are disposed in the sub-sensing regions of the corresponding sensing region respectively, and each of the sub-driving pattern electrodes has a driving circumference, wherein the driving circumferences of the sub-driving pattern electrodes in the sub-sensing regions of each of the sensing regions are different.

20. A touch sensing panel, comprising:
a substrate having a plurality of sensing regions, each of the sensing regions comprising a plurality of sub-sensing regions;
a plurality of sensing electrodes, each of the sensing electrodes having a plurality of sub-sensing pattern electrodes, wherein the sub-sensing pattern electrodes of each of the sensing electrodes are disposed in the sub-sensing regions of a corresponding sensing region respectively; and
a plurality of driving electrodes, each of the driving electrode having a plurality of sub-driving pattern electrodes, the sub-driving pattern electrodes of each of the driving electrodes disposed in the sub-sensing regions of a corresponding sensing region respectively, and each of the sub-driving pattern electrodes having a driving circumference, wherein the driving circumferences of the sub-driving pattern electrodes in the sub-sensing regions in each of the sensing regions are different.
